(19) United States
(12) Patent Application Publication
(10) Pub. No.: US 2012/0094057 A1
(43) Pub. Date: Apr. 19, 2012

(54) POROUS ANTI-SLIP FLOOR COVERING

(76) Inventor: Joel Patrick Bartlett, Fort Lauderdale, FL (US)

(21) Appl. No.: 13/228,525

(22) Filed: Sep. 9, 2011

Related U.S. Application Data
(60) Provisional application No. 61/393,012, filed on Oct. 14, 2010.
(60) Provisional application No. 61/393,503, filed on Oct. 15, 2010.

(51) Int. Cl. D04H 11/00; B32B 37/14

(52) U.S. Cl. 428/92; 156/62.2

(57) ABSTRACT

A flooring assembly and method of manufacturing a flooring assembly includes forming a. working surface by depositing a plurality of heated flexible strands of material onto a surface and cooling the plurality of heated flexible strands so that a first end of each strand is directly physically coupled to a first end of at least one other strand in the plurality of strands so that the coupled first ends of the plurality of strands define a plurality of openings and a second end, opposite the first end, of each strand is physically independent from each second end of each of the strands in the plurality of strands so that each second end of each strand is able to move independent of the second end of each other strand. The method further includes providing a mesh underlayment having an upper surface, an opposing lower surface, and defining a plurality of openings spanning from the upper surface to the lower surface and permanently adhering the coupled first ends of the plurality of strands to the upper surface of the underlayment.

### CROSS REFERENCE TO RELATED APPLICATION

This application claims the benefit of U.S. Provisional Application No. 61/393,012, filed on Oct. 14, 2010, and U.S. Provisional Application No. 61/393,503, filed on Oct. 15, 2010, the prior applications are herewith incorporated by reference in their entirety.

### FIELD OF THE INVENTION

The present invention relates generally to a floor-covering material and, more particularly, to a floor-covering material that is particularly suited for moisture-prone applications and that provides superior traction and comfort,

### BACKGROUND OF THE INVENTION

The flooring surfaces of marine vessels, which are generally made of fiberglass, aluminum, or wood, are typically provided with gelcoat or a coat of marine-grade paint and either left uncovered or are covered with a marine-grade floor covering, e.g., a carpet material. When left uncovered, the flooring surface can be slippery, often gets hot due to direct exposure to the sun, and is, generally, not very comfortable to bare feet. Unfortunately, presently-known floor coverings suffer from many shortcomings as well. For example, carpet material, which, due to its presence on a boat deck, is exposed to the elements, e.g., intense sunlight/heat, rain, humidity, etc. This exposure causes rapid deterioration of the material and replacement is frequently necessary. The deterioration is accelerated by the carpet material's retention of moisture, which results in the development of mold and mildew. Furthermore, flooring made from carpet materials tend to be difficult to hold in place without adhesive, which can be difficult to deal with when the carpet has to be removed and replaced.

One alternative material that does not absorb moisture is matting material distributed under the name 3M™ Nomad™ Vinyl Scraper Matting. This material has a top surface made of a coiled web of continuous filaments and is provided either with a solid backing material or without any backing material at all. Notably, the Nomad™ matting has a coiled web of continuous filaments that are stiff and are intended to serve as a resistive material that scrapes debris from shoe soles. This stiff coiled web of filaments is, therefore, not suitable for applications in which bare feet or bare skin contact the filaments for any length of time. Moreover, neither the matting having the solid backing material nor the unbacked matting is suitable for placement on the deck of a marine vessel. Particularly, the unbacked matting is not suitable for appropriately gripping the deck of the marine vessel and the backed material results moisture being retained between the deck of the marine vessel and the backing, which can result in the growth of mold and mildew between the surfaces.

Other options for covering the deck of a marine vessel are hardened vinyl and perforated rubber, which are not aesthetically pleasing or comfortable on bare feet.

Therefore, a need exists to overcome the problems with the prior art as discussed above.

### SUMMARY OF THE INVENTION

The invention provides a porous anti-slip floor covering that overcomes the hereinabove-mentioned disadvantages of the heretofore-known devices and methods of this general type and that provides floor covering that can be implemented in an efficient manner, is aesthetically pleasing, and provides comfort to the bare feet of a user.

With the foregoing and other objects in view, there is provided, in accordance with the invention, a flooring assembly that includes an underlayment with an upper surface, an opposing lower surface, and defining a plurality of voids extending from the upper surface to the lower surface. A working layer is disposed on top of the underlayment, the working layer including a plurality of flexible curled strands, each curled strand having a first end and a second end opposite the first end, the first end of each curled strand being directly physically coupled to a first end of at least one other of the curled strands in the plurality of curled strands and, together, defining a lower surface and the second end of each curled strand being physically independent from each second end of each of the curled strands in the plurality of curled strands, wherein each second end of each curled strand is able to move independent of the second end of each other curled strand and the coupled first ends of the plurality of curled strands define a plurality of openings thereat.

In accordance with a further feature of the present invention, the curled strands are formed from PVC material.

In accordance with another feature of the present invention, the working layer and the underlayment are waterproof.

In accordance with one more feature of the present invention, the working layer is between about 8 mm to about 18 mm in height.

In accordance with an additional feature of the present invention, the curled strands are coated in a PLASTISOL material.

In accordance with a further feature of the present invention, the underlayment is of a non-marking material.

In accordance with still another feature of the present invention, the underlayment has a first frictional coefficient and the working layer has a second frictional coefficient, the first frictional coefficient being larger than the second frictional coefficient.

In accordance with yet one more feature of the present invention, the lower surface of the underlayment has a shape that defines a plurality of water channels between the lower surface of the underlayment and a surface upon which the lower surface of the underlayment is placed.

In accordance with additional feature of the present invention, the lower surface of the underlayment is provided with legs that define a plurality of water channels between the lower surface of the underlayment and a surface upon which the lower surface of the underlayment is placed.

In accordance with the present invention, a method of manufacturing a flooring assembly includes forming a working surface by depositing a plurality of heated flexible strands of material onto a surface and cooling the plurality of heated flexible strands so that a first end of each strand is directly physically coupled to a first end of at least one other strand in the plurality of strands so that the coupled first ends of the plurality of strands define a plurality of openings and a second end, opposite the first end, of each strand is physically independent from each second end of each of the strands in the plurality of strands so that each second end of each strand is able to move independent of the second end of each other strand. The method further includes providing a mesh underlayment having an upper surface, an opposing lower surface, and defining a plurality of openings spanning from the upper surface to the lower surface and permanently adhering the coupled first ends of the plurality of strands to the upper surface of the underlayment.

In accordance with a feature of the present invention, a method of manufacturing a flooring assembly further includes applying a coating of PLASTISOL to the working layer and applying a coating of PLASTISOL to the underlayment.

In accordance with a feature of the present invention, a method of manufacturing a flooring assembly also includes applying heat to the working surface and the mesh underlayment so that the PLASTISOL reaches a melting point.

Although the invention is illustrated and described herein as embodied in a porous anti-slip floor covering, it is, nevertheless, not intended to be limited to the details shown because various modifications and structural changes may be made therein without departing from the spirit of the invention and within the scope and range of equivalents of the claims, Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is an elevational side view of a porous anti-slip floor-covering assembly in accordance with an exemplary embodiment of the present invention;

FIG. 2 is an elevational side view of a conveyer belt and hopper device and shows a manufacturing process for manufacturing a working layer of the porous anti-slip floor-covering assembly of FIG. 1 in accordance with an exemplary embodiment of the present invention;

FIG. 3 is an elevational side cross-sectional view of an underlayment of the porous anti-slip floor-covering assembly of FIG. 1 supported by a flooring surface in accordance with an exemplary embodiment of the present invention;

FIG. 4 is a plan view of the underlayment of FIG. 3;

FIG. 5 is a process flow diagram of a process of manufacturing the porous anti-slip floor-covering assembly of FIG. 1 in accordance with an exemplary embodiment of the present invention;

FIG, 6 is an devotional side view of a porous anti-slip floor-covering assembly in accordance with an exemplary embodiment of the present invention;

FIG. 7 is a partial perspective view of the underside of an underlayment of the porous anti-slip floor-covering assembly of FIG. 6 in accordance with an exemplary embodiment of the present invention; and

FIG. 8 is a downward-looking partial perspective view of two porous anti-slip floor-covering assemblies of FIG. 6 being coupled to each other.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel anti-slip, anti-stain, anti-fade, and anti-mold water-shedding floor covering that does not store moisture. Embodiments of the invention provide an upper layer of resilient flexible coiled waterproof fibers disposed in a loosely-organized fashion on a solid layer of porous anti-slip material. In addition, embodiments of the invention provide a stain-free, fade-free, slip-free, mold-free decorative flooring for boats, pool areas, porches, patios, or anywhere else.

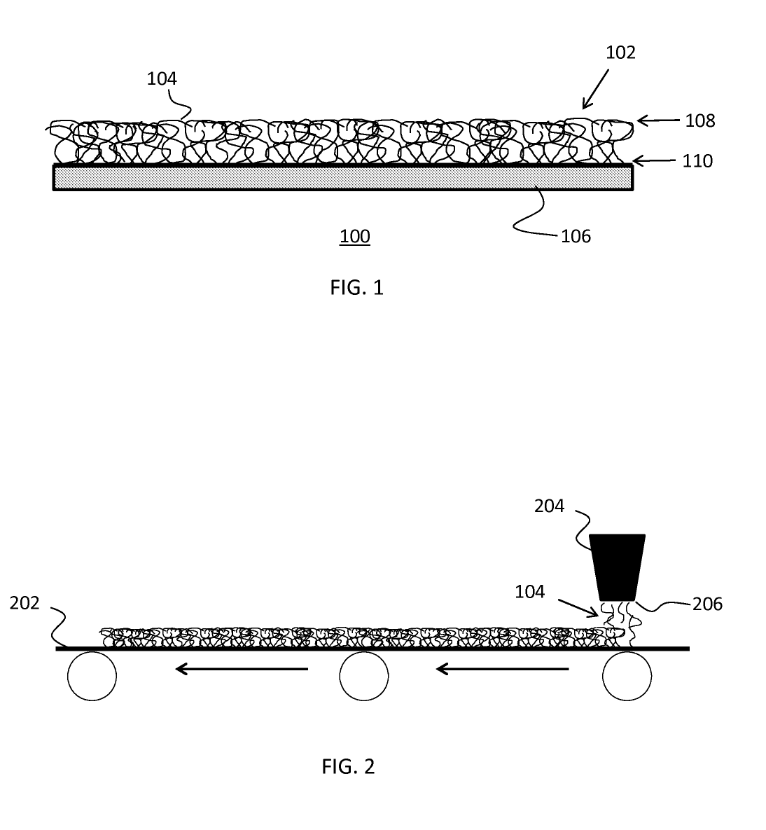

Referring now to FIG. 1, one embodiment of the present invention is shown in an elevational edge view. FIG. 1 shows several advantageous features of the present invention, but, as will be described below, the invention can be provided in several shapes, sizes, combinations of features and components, and varying numbers and functions of the components. The first example of a novel floor-covering assembly 100, as shown in FIG. 1, includes a working layer 102 composed of curled strands of material 104 disposed on top of an underlayment 106. When in use, the underlayment 106 is placed onto a flooring surface so that the working layer 102 faces up and is visible to the observer. It is the working layer 102 that will make contact with a user walking over or sitting on the flooring surface once the inventive flooring assembly 100 is installed. The working layer 102 will be described with reference to its upper working surface 108 and lower working surface 110.

Although other materials may be utilized, in accordance with one embodiment of the present invention, the curled strands 104 are formed of extruded polyvinyl chloride (PVC) material. The PVC can be either new or recycled from other applications of PVC. A curled strand formation process is illustrated in the elevational side view of FIG. 2, which shows a conveyor belt-type substantially continuous/planar intermediate surface 202 passing under a hopper 204. When the process is in operation, the hopper 204 is caused to emit segments of extruded PVC material 104 from its outlet 206. As the hopper 204 emits the extruded PVC material 104, it falls onto the intermediate surface 202 in a shape that resembles spaghetti. Throughout this operation, the working layer 102 of curled strands of material 104 are continuously extruded onto the substantially continuous/planar intermediate surface 202. As the curled strands of material 104 are emitted, they enjoy substantial flexibility in their shape due to the increased temperature applied during the extrusion process. Because of this increased temperature, as the strands of material 104 reach the intermediate surface 202, they are able to conform at one of their ends to the planar shape of the intermediate surface 202. In other words, the lower working surface 110 will receive the profile of the continuous intermediate surface 202, giving each of the individual strands of material 104 a partially flattened side, depending on the latent heat of the strands of material 104 when deposited onto the intermediate surface 202. This flattened side forms and becomes the lower working surface 110.

Upon being deposited on the intermediate surface 202, cooling occurs relatively rapidly. As the cooling occurs, the shape of the upper portion of the strands of material 104 locks into random spaghetti shapes that resemble that shown in FIGS. 1 and 2. The spaghetti shape of each strand of material 104 leaves considerable space between each adjacent strand of material 104. As will be explained below, the spacing between the strands is advantageous in its ability to allow water and other liquids or substances to easily pass from the upper working surface 108 to the lower working surface 110 of the working layer 102.

PVC material has many advantages over prior-art flooring material. For example, PVC material does not absorb water like carpets and other materials that are commonly used as outdoor flooring, e.g., boat flooring. PVC material is extremely durable and is not likely to show wear over time, as would typical flooring materials. Furthermore, PVC material 104 extruded in small strands, such as that making up the working layer 102 of the floor covering assembly 100, expresses great flexibility and resilience to return to its original shape. This provides a comfortable surface against the user's feet as they walk on the working layer 102. In addition to comfort, the easily temporarily deformed strands of PVC material 104 create depressed areas in the shape of the users foot, which results in secure, slip-free footing for the user. Advantageously, the PVC material 104, in accordance with an embodiment of the present invention, can be further softened by adding fillers of, for instance, petroleum and limestone, which results in increased flexibility of each of the strands of PVC material 104 and provides even further comfort and secure footing on the floor covering assembly at the working surface 102.

Embodiments of the present invention provide the PVC material 104 with ultraviolet (UV) stabilizers, which allow the working layer 102 of the floor covering assembly 100 to withstand extensive exposure to sunlight. UV stabilizers are well known in the art. In addition, pigments can be easily added to the PVC material 104 to produce a virtually unlimited number of colors, shapes, and patterns that can be provided in the working layer 102.

Returning to FIG. 1, the lower working surface 110 is shown supported by and coupled to the underlayment 106. The underlayment 106 provides a surface for making contact with the flooring material. Preferably, the underlayment 106 has a frictional coefficient that is greater than a frictional coefficient of the lower working surface 110, which helps keep the floor covering assembly 100 in a static fixed location above the floor on which it is placed. If the frictional coefficient of the underlayment 106 is great enough, advantageously, the inventive floor covering assembly 100 does not need to be glued or otherwise permanently attached to the floor, as does other prior-art flooring materials. This provides a tremendous advantage over the prior art, as the inventive floor covering assembly 100 can simply be lifted up when desired ability that prior-art flooring materials do not and cannot enjoy.

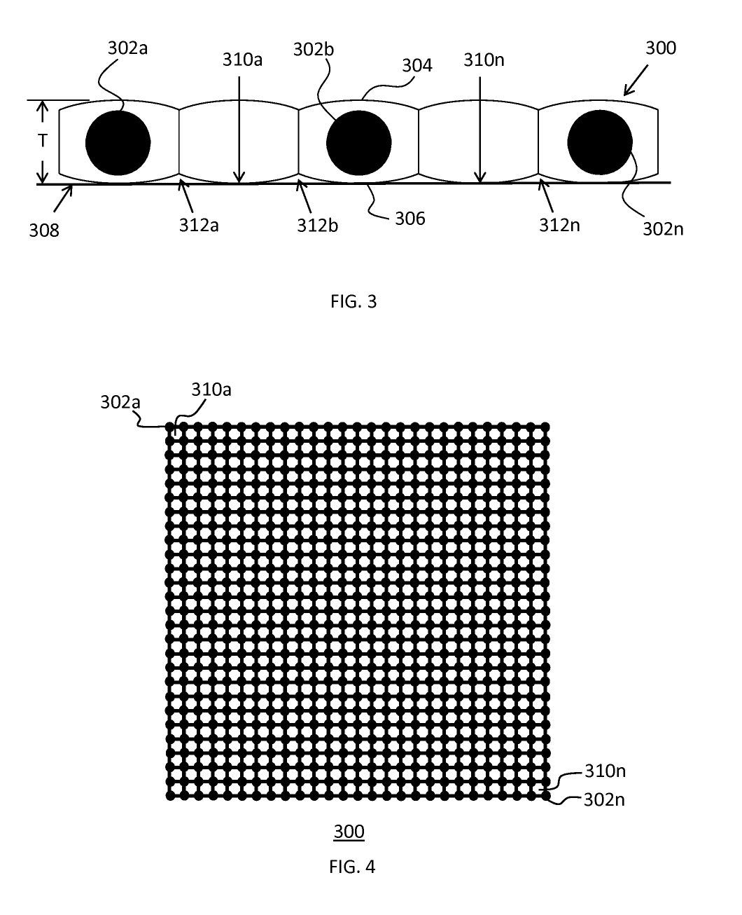

In accordance with one embodiment of the present invention, the underlayment 106 is a mesh substrate 300, as shown in the elevational edge view of FIG. 3. The mesh substrate 300 is preferably made of a clear dye-free polyvinyl material. Several such materials are known in the art, By providing a mesh substrate 300 that is free of dyes, staining, for instance, of a boat hull, can be avoided, even when the mesh substrate 300 is exposed to high temperatures from the sun. This property is advantageous, as boat hulls are often white. The inventive flooring material can be used in many other applications where a non-staining material is also desirable. The mesh substrate 300 may be defined by strands 302a-n having a net/grid geometry. The indicator “a-n,” as used herein, represents any range of elements from 1 to infinity. In this case, the grid geometry of the mesh substrate 300 can by formed from a number of strands 302 from one to infinity, depending on the size of the area to be covered. The strands can be of polyester or other similar material. In the view provided in FIG. 3, on the strands 302a-n are shown as running perpendicular to the plane of the drawing page. A second set of non-illustrated strands are present within the mesh substrate and run perpendicular to the illustrated strands 302a-n, i.e., parallel with the drawing page. In accordance with one embodiment, the strands 302 are of a polyester material. During the manufacturing process, they are provided with a PLASTISOL coating and are then oven cured to set the PLASTISOL into a solid, but flexible state.

In accordance with embodiments of the present invention, both the working layer 102 and the underlayment 106 are waterproof. Waterproof, as used herein, is intended to indicate a material that is relatively unaffected. by water and resists the penetration or permeation of water and water vapors.

The mesh substrate 300 is preferably provided with an overall thickness T between about 8 mm to about 18 mm, with 8 mm being the preferred thickness. The mesh substrate 300 has a upper surface 304, which is the surface that makes contact with and is coupled to the lower working surface 110 of the working layer 102 of the flooring assembly 100 (see FIG. 1). On the opposite side, the mesh substrate 300 has an application surface 306 which is placed upon and makes contact with a surface 308 of, for instance, a marine vessel.

As shown in the downward-looking plan view of FIG. 4, the mesh substrate 300 defines voids 310a-n created by the criss-crossed grid pattern of the polyester strands 302a-n. The voids 310a-n pass from the upper surface 304 of the mesh substrate 300 to the application surface 306 of the mesh substrate 300. The voids 310a-n allow liquid and particles to easily and quickly pass through to the surface 308 upon which the flooring assembly is installed.

The repeating curved shape of the application surface 306 (see FIG. 3) provides a plurality of channels 312a-n that fluidically interconnect the voids 310a-n formed by the mesh substrate 300. In other words, the channels 312a-n form fluid connections between the fluid exits of the voids 310a-n. The channels 312a-n provide a passage at the application surface 306 of the mesh substrate 300, which allows liquid and particulate to drain between the mesh substrate 300 and the surface 308 upon which it is installed, e.g., a deck of a marine vessel. While the channels 312a-n are indicated in FIG. 3 as being disposed at the corners of the voids 310a-n, it is also possible for the channels to be provided at the centers of the voids 310a-n as well. It should be noted, however, that channels are not necessary for practicing the present invention.

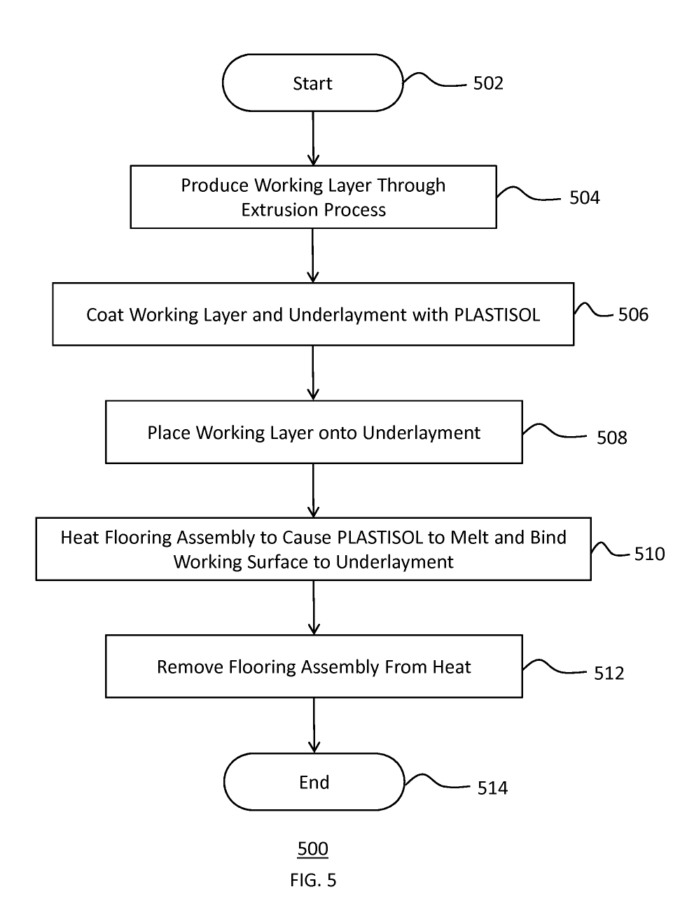

For permanent attachment of the working layer 102 to the underlayment 106, applicant discovered that extrusion strands 104 directly onto the mesh substrate 300 resulted in the strands 104 sealing the voids 310a-n in the mesh substrate 300, which in turn would prevent liquid from passing through the voids 310a-n. After extensive testing, it was discovered that producing the inventive flooring assembly in the manner partially illustrated in FIG. 2 and shown in the process flow diagram of FIG. 5 derived a product that expressed all of the above-mentioned advantageous features and that fulfilled all of the needs not met by prior-art flooring products.

Looking now to FIG. 5, the process 500 begins at step 502 and moves directly to step 504 where the working layer 102 is formed in the manner shown in FIG. 2, i.e., as a homogeneous layer created through an extrusion process. Once formed, the working layer 102 is attaching it to the underlayment 106 in a separate steps 506-510, which results in a multi-layered structure that allows fluids and particles to easily pass through both layers 102, 106. More specifically, in step 506, prior to coupling the working layer 102 to the underlayment 106, both layers 102, 106 are coated in a PLASTISOL material. Other similar materials can be used as well. By controlling the viscosity of the PLASTISOL material, i.e., keeping it low enough, the spaghetti-like upper portions of the strands 104 do not adhere to each other but, instead, retain their flexible independent movement from each other.

In step 508, the lower working surface 110 of the working layer 102 is placed directly on the upper surface 304 of the underlayment 106. The two layers 102, 106 are then subjected, in step 510, to a temperature sufficient to cause the PLASTISOL to melt and adhere the working layer 102 to the underlayment 106 (mesh substrate 300). In step 512, the flooring assembly 100 is removed from the heat and, in step 514, the process ends. The result is a novel anti-slip floor covering that allows water or other liquids to immediately pass therethrough. In alternative steps that precede step 504, anti-stain and/or anti-fade and/or anti-mold additives can be added to the material, e g., PVC, prior to the extrusion process. In other embodiments, anti-stain and or anti-fade and/or anti-mold additives are applied to the working layer after the extrusion process. Anti-fade, as used herein, is intended to indicate a material that will endure approximately 1500 hours of exposure to sunlight without evidencing a noticeable change in color properties. To achieve anti-mold properties, anti-microbial composites are added to the materials. Anti-stain, as used herein, is intended to indicate a material that will not readily absorb pigment.

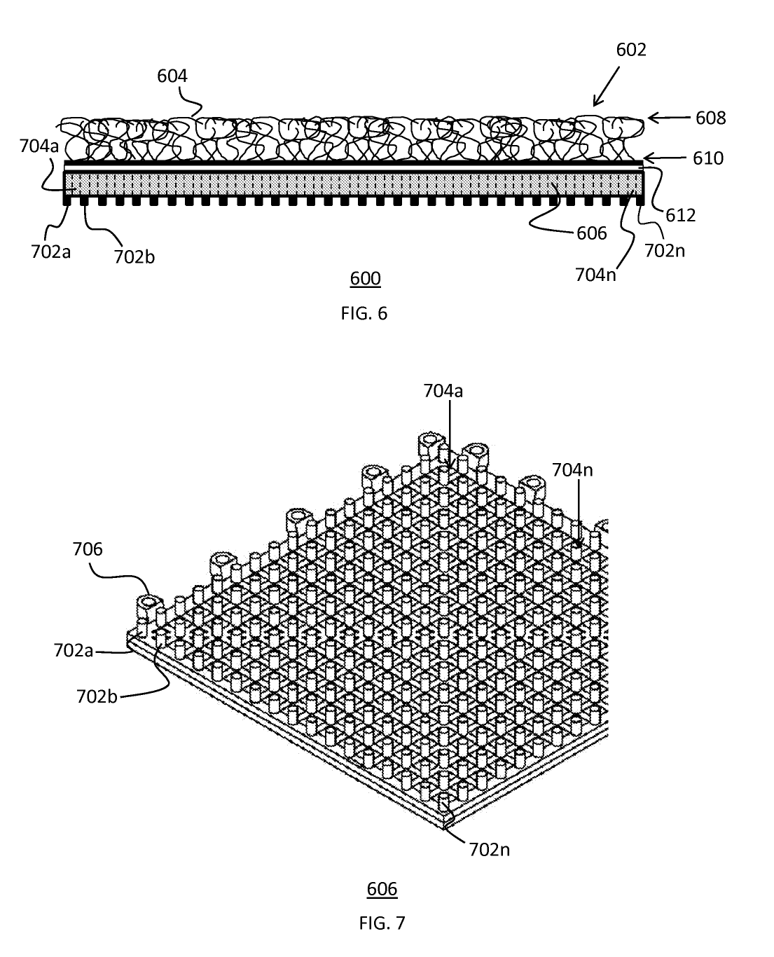

In FIGS. 6 and 7, another embodiment of a floor-covering assembly 600 is depicted. The embodiment of a floor-covering assembly 600 is useful as an area rug for use on, for example, boat docks. As seen in FIG. 6, the floor covering assembly 600 includes a working layer 602 composed of curled strands of material 604 disposed on top of an underlayment 606 with a mesh substrate 612 disposed there between. When in use, the underlayment 606 is placed onto a flooring surface and the working layer 602 faces up and is visible to the Observer. It is the working layer 602 that will make contact with a user walking over the flooring surface once the inventive flooring assembly 600 is installed. For ease of description herein, the working layer 602 will be described with reference to its upper working surface 608 and lower working surface 610.

Referring now to FIG. 7, the underlayment 606 is shown in a partial perspective underside view. The underlayment 606 has a lattice construction that defines a plurality of voids 704a-n. The voids 704a-n pass from an upper surface of the underlayment 606 to the lower surface of the underlayment 606 shown in the underside view of FIG. 7. In addition, in accordance with one embodiment of the present invention, a plurality of legs 702a-n are disposed on the underside of the underlayment 606 and elevate the underlayment 606 from the surface upon which it is placed. The plurality of legs 702a-n advantageously form channels that allow liquid and particulate to drain between the underlayment 606 and the surface upon which it is installed, e.g., a pool deck. In accordance with one embodiment, the underlayment 606 is formed of injection molded plastic.

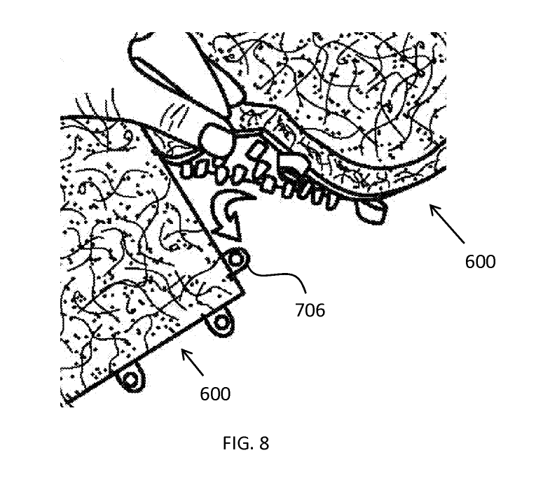

The underlayment 606 further includes one or more couplers 706, which can be used to couple an adjacent floor covering assembly 600 for the purpose of providing a configurable and expandable flooring surface. FIG. 8 shows a user coupling two floor covering assemblies 600 to each other by inserting one of the outer edge legs 702a-n into the coupler 706 of an adjacent floor covering assembly 600. If the legs 702a-n are of sufficient strength, the coupling between the floor covering assemblies 600 is secure and the multiple connected floor covering assemblies 600 perform as if the multiple connected floor covering assemblies 600 were a unitary piece of flooring material.

Referring back to FIG. 6, the floor-covering assembly 600 includes a mesh substrate 612 located between the working layer 602 and the underlayment 606. The mesh substrate 612 is porous and, in accordance with an embodiment of the present invention, features a grid pattern, e.g., similar in construction to the mesh substrate 300 shown in FIG. 3. That is, the mesh substrate 612 is provided with pores or voids that allow moisture to pass therethrough. However, because the mesh substrate 612 is disposed directly between the underlayment 606 and the lower working surface 610 of the working layer 602, it is not necessary for the application surface of the mesh substrate 612 to have the channels or fluidic connections, such as channels 312a-n, as were shown in HG. 3.

The mesh substrate 612 disposed between the working layer 602 and the underlayment 606 provides several advantages. First, the mesh substrate 612, which has pores or voids that are much smaller than the voids 704a-n of the underlayment 606, supports the tower working surface 610 of the working layer 602 and prevents it from falling within and conforming to the voids 704a-n of the underlayment 606. Second, the inventive flooring assembly 600 is intended be utilized in outdoor conditions that can experience drastic variations in temperatures. These temperature gradients have been found to result in an expansion and contraction of the under 606 that is not equal to a corresponding expansion and contraction of the working layer 602. Advantageously, the mesh substrate 612 serves as a buffer to the two layers. Additionally, the mesh substrate 612 provides an improved bonding surface for both layers to adhere to one another.

For each of the embodiments shown and described herein, patterns and logos can be cut out of the working surface material and fit into a second working surface with contrasting colors and having a corresponding same shape cutout. In addition to flooring, the presently-inventive flooring products have been found useful in other applications. For example, at least the working surface has been found to be very well suited as a saddle pad, where it provides insulation between the horse and saddle. In addition, the flooring assembly can be used as a bed liner of a truck, as a pet mat, in the door area of ski resorts, under water fountains, under ice machines, as flooring behind bars or food-preparation lines, on any other floor area, and many more.

A floor mat assembly has been disclosed that can be utilized in many applications and that readily passes liquid and other particulates therethrough, while maintaining an attractive appearance, similar to that of high-grade carpet materials. The inventive product is durable in shape, resists fading, resists mold, is not water soluble, and provides superior traction.

What is claimed is:

1. A flooring assembly comprising:
an underlayment having an upper surface, an opposing lower surface, and defining a plurality of voids extending from the upper surface to the lower surface; and
a working layer disposed on top of the underlayment, the working layer including a plurality of flexible curled strands, each curled strand having a first end and a second end opposite the first end, the first end of each curled strand being directly physically coupled in a first end of at least one other of the curled strands in the plurality of curled strands and, together, defining a lower surface and the second end of each curled strand being physically independent from each second end of each of the curled strands in the plurality of curled strands, wherein each second end of each curled strand is able to move independent of the second end of each other curled strand and the coupled first ends of the plurality of curled strands define a plurality of openings thereat.

2. The flooring assembly according to claim 1, wherein:
the curled strands are formed from PVC material.

3. The flooring assembly according to claim 1, wherein:
the working layer and the underlayment are waterproof.

4. The flooring assembly according to claim 1, wherein:
the working layer is between about 8 mm to about 18 mm in height.

5. The flooring assembly according to claim 1, wherein:
the curled strands are coated in a PLASTISOL material.

6. The flooring assembly according to claim 1, wherein:
the underlayment is of a polyvinyl material.

7. The flooring assembly according to claim 1, further comprising:
a mesh substrate disposed between the working layer and the underlayment.

8. The flooring assembly according to claim 1, wherein:
the underlayment has a first frictional coefficient and the working layer has a second frictional coefficient, the first frictional coefficient being larger than the second frictional coefficient.

9. The flooring assembly according to claim 1, wherein:
the lower surface of the underlayment has a shape that defines a plurality of water channels between the lower surface of the underlayment and a surface upon which the lower surface of the underlayment is placed.

10. The flooring assembly according to claim 1, wherein:
the lower surface of the underlayment is provided with legs that define a plurality of water channels between the lower surface of the underlayment and a surface upon which the lower surface of the underlayment is placed.

11. A method of manufacturing a flooring assembly, the method comprising:
forming a working layer by:
depositing a plurality of heated flexible strands of material onto a surface;
cooling the plurality of heated flexible strands so that:
a first end of each strand is directly physically coupled to a first end of at least one other strand in the plurality of strands so that the coupled first ends of the plurality of strands define a plurality of openings; and
a second end, opposite the first end, of each strand is physically independent from each second end of each of the strands in the plurality of strands so that each second end of each strand is able to move independent of the second end of each other strand;
providing a mesh underlayment having an upper surface, an opposing lower surface, and defining a plurality of openings spanning from the upper surface to the lower surface; and
permanently adhering the coupled first ends of the plurality of strands of the working layer to the upper surface of the mesh underlayment.

12. The method according to claim 11, further comprising:
applying a coating of PLASTISOL to the working layer; and
applying a coating of PLASTISOL to the underlayment.

13. The method according to claim 12, wherein the adhering step comprises:
applying heat to the working surface and the mesh underlayment so that the PLASTISOL reaches a melting point.

14. The method according to claim 11, wherein:
the flexible strands of material are formed from PVC material.

15. The method according to claim 11, wherein:
the working layer and the underlayment are waterproof.

16. The method according to claim 11, wherein:
the working layer is between about 8 mm to about 18 mm in height.

17. The method according to claim 11, wherein:
The mesh underlayment is of a polyvinyl material.

18. The method according to claim 11, further comprising:
a mesh substrate disposed between the working layer and the mesh underlayment.

19. The method according to claim 11, wherein:
the mesh underlayment is provided with a first frictional coefficient and the working layer is provided with a second frictional coefficient, where the first frictional coefficient is larger than the second frictional coefficient.

20. The method according to claim 11, further comprising:
forming channels in the lower surface of the underlayment, the channels defining a plurality of water channels between the lower surface of the underlayment and a surface upon which the lower surface of the underlayment is placed.
